(19) United States
(12) Patent Application Publication
(10) Pub. No.: US 2004/0155188 A1
(43) Pub. Date: Aug. 12, 2004

(54) Infrared sensor and method for making same

(76) Inventors: Markus Kohli, Morges (CH); Andreas Seifert, St Sulpice (CH); Bert Willing, St Prex (CH)

Correspondence Address: GRIFFIN BUTLER WHISENHUNT & SZIPL LLP, SUITE PH-1, 2300 NINTH STREET SOUTH, ARLINGTON, VA, 222042396

(21) Appl. No.: 10/479,850

(22) PCT Filed: Jun. 8, 2001
(86) PCT No.: PCT/EP01/06630

(51) Int. Cl. G01J 5/00

(52) U.S. Cl. 250/338.1

(57) ABSTRACT

The invention concerns an infrared sensor (2) comprising a plurality of pixels (12) having a structured layer (20) for infrared light absorption located at the sensor upper surface. The invention is characterised in that the absorption layer (20) is formed of colloidal particles, in particular graphite or metal oxide wafers embedded or sealed in a binder. The method for making such a sensor consists in forming the structured layer by deposit of the colloidal particles in accordance with a standard technique and then in eliminating partly the thus formed absorption layer to obtain a plurality of elementary absorption zones respectively associated with the plurality of pixels.

The present invention concerns infrared sensors including a light absorption layer which is structured, i.e. this layer partially covers the substrate of the sensor forming a plurality of elementary infrared light absorption zones respectively associated with a plurality of pixels forming this sensor.

Forming such structured absorption layers by thermal vacuum deposition of a metal in a nitrogen atmosphere of several millibars, to obtain a black texture having a good infrared light absorption coefficient, is known. This is known as “black” gold or silver. This technique of forming absorption layers has at least two drawbacks. First of all, the equipment required is relatively expensive, which increases the production costs of the sensor. Secondly, deposition of a “black” metal is sometimes accompanied by problems of adherence of the layer deposited on the substrate.

Forming such structured absorption layers by electrochemical growth of a platinum layer with a high current density so as to obtain a dendritic growth, which gives the layers its black colour, is also known. This is called “black” platinum. This process also has drawbacks. First of all, the platinum salt used is relatively expensive. Next, the dendritic growth conditions depend relatively strongly on the substrate surface on which the structured layer is made. Thus, if the substrate surface is not perfectly homogenous, different growths are obtained depending on the areas, which leads to different absorption coefficients according to the pixels of a sensor or a plurality of sensors manufactured in batches. This fact is particularly disastrous for industrial production. Finally, the electrochemical process requires all of the pixels of one sensor to be electrically connected to allow deposition in the corresponding elementary zones. These electrical connections then have to be removed for the sensor to be able to operate properly.

It is an object of the present invention to overcome the aforementioned financial and technical drawbacks, by providing an inexpensive manufacturing process for a structured absorption layer and a sensor having such a layer with homogenous physical features for all of the pixels of a sensor and more generally for a plurality of sensors manufactured in batches.

The invention therefore concerns a method for manufacturing at least one infrared sensor wherein there is provided a step for forming a structured infrared light absorption layer at the top surface of a substrate in which a plurality of pixels of said at least one infrared sensor are partially formed. This method is characterized in that, in the step for forming the structured layer, a dispersion of colloidal particles is deposited so as to form a layer that is preferably substantially uniform, covering said substrate and this layer is then partially removed so as to form a plurality of elementary absorption zones respectively associated with said plurality of pixels and defining said structured layer.

Owing to the features of the method according to the invention, it is possible to deposit a structured infrared light absorption layer using relatively inexpensive equipment, for example a spinner, or simply by spraying, particularly using a spraying device.

The colloidal particles define black pigments, for example graphite plates or metal oxides. The graphite or metal oxide dispersions are relatively easy to prepare and certain dispersions offered on the market answer the criteria necessary to obtain a layer of binding agent with colloidal particles defining a homogenous layer with a substantially constant thickness and adhering well to the substrate.

The invention also concerns an infrared sensor including a structured light absorption layer, characterized in that this structured layer is formed of colloidal particles and a binding agent. In particular, the colloidal particles are graphite plates or metal oxides.

The present invention will be explained in more detail using the following description, made with reference to the annexed drawing, given by way of non-limiting example, in which:

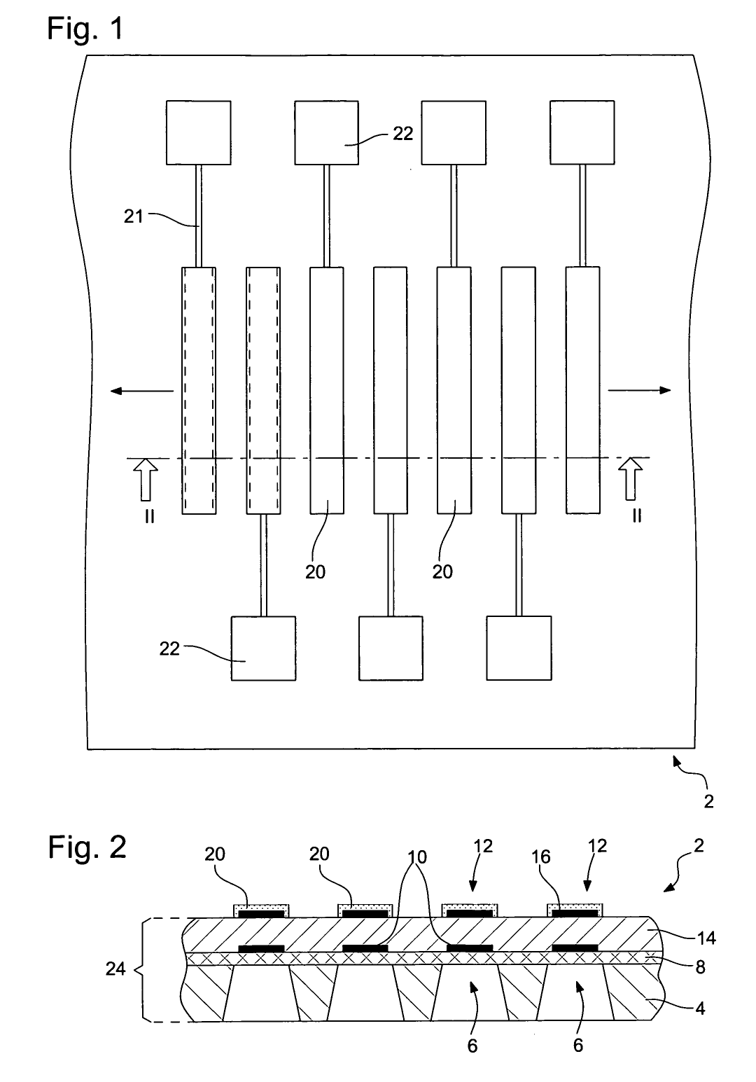

FIG. 1 is a partial schematic top view of a first embodiment of an infrared sensor according to the invention; and

FIG. 2 is a schematic cross-section along the line II-II of FIG. 1.

FIGS. 1 and 2 show schematically and partially an infrared sensor 2 formed in a silicon plate 4 in which a plurality of recesses 6 has been micro-machined. These recesses end in a layer or membrane 8 on which are formed the bottom electrodes 10 of the pixels 12 of sensor 2. Above membrane 8 and electrodes 10 there is formed a pyroelectric layer 14, which in the variant shown here passes between pixels 12. However, in another variant, layer 14 can be structured so as to isolate pixels 12. Top electrodes 16 are formed on layer 14. The structured infrared light absorption layer is arranged above electrodes 16. Absorption layer 20 thus defines a plurality of elementary absorption zones respectively associated with the plurality of pixels of sensor 2.

It will be noted that the invention is specifically relevant to structured absorption layer 20 and the method of depositing said layer. Thus, the present invention can be applied to any type of infrared sensor or detector, particularly for bolometers or thermal elements (thermoelectric batteries). The use of a pyroelectric layer is thus in no way limiting and is given here solely by way of example.

According to another embodiment of an infrared sensor according to the invention, the structured absorption layer defining the elementary zones is electrically conductive and also forms the top electrodes of the plurality of pixels 12. As shown in FIG. 1, each of top electrodes 16 is electrically connected by a conductive path 21 to a contact pad 22.

According to the invention, structured absorption layer 20 is formed of colloidal particles and a binding agent, which coagulates the colloidal particles and also ensure that the absorption layer adheres well to substrate 24 (including electrodes 16) at the surface of which it is arranged. In particular, in the case of FIG. 2, a high level of adhesion has to be achieved between structured layer 20 and electrodes 16.

“Colloidal particles” means particles of small dimensions, of the order of several micrometers or smaller dimensions. Within the scope of the present invention, particles with larger dimensions are also included in this definition, particularly plates whose diameter or largest dimension can go up to approximately 100 micrometers.

However, in order to obtain relatively thin and homogenous layers, most of said graphite plates preferably have diameters less than 40 micrometers. In a non-limiting manner, the absorption layer generally has a thickness of less than 10 micrometers. Preferably, layers according to the invention having a thickness of between approximately 1 and 3 micrometers are deposited.

In another embodiment, the colloidal particles are formed by metal oxides, particularly iron, copper or manganese oxides. The metal oxides form the pigments of a dispersion, the other elements of which are selected by those skilled in the art so as to allow deposition of a homogenous layer exhibiting a high level of adherence to the substrate.

The manufacturing method according to the invention and the composition of the dispersion used will be described hereinafter more particularly for graphite plates used as infrared light absorption material.

The dispersion used to form the structure absorption layer contains an aqueous or organic solvent, in which the pigments are dispersed, i.e. the colloidal particles according to the invention. The percentage by weight of these pigments greatly depends on their type and the thickness of the absorption layer provided. By way of example, the proportion of pigments can vary between approximately 10% and 60% by weight. As regards the dimensions of the pigments, an optimum has to be determined as a function of the features desired for the deposited layer. In the case of graphite plates, their diameters are preferably less than 40 micrometers to obtain layers whose thickness varies between approximately 1 and 3 micrometers with a very good absorption coefficient, preferably higher than 90%.

In addition to the solvent, the dispersion includes dispersion agents, which ensure a substantially homogenous distribution of the particles in the dispersion and prevents them clustering or forming sediment. Finally, the dispersion includes a binding agent, particularly an acrylic resin, which, after the solvent has vaporized, ensure cohesion between the particles and their adhesion to the substrate on which the dispersion has been deposited. Preferably, the binding agent is one that undergoes a chemical reaction when the solvent evaporates so as to ensure that once the layer has been deposited and become solid, the binding agent is no longer soluble in the solvent initially present in the dispersion and also in other solvents with which the structured layer thereby formed may come into contact.

One could also introduce into the solvent a material that modifies the mechanical properties of the deposited layer, particularly polyester molecules, which increase adhesion with the substrate. Finally, the dispersion can contain wetting agents, which increase the wettability of the dispersion on the substrate so as to allow deposition of a uniform layer of substantially constant thickness.

Such dispersions can be added relatively easily by spin-coating, dip-coating or spray-coating. Once the dispersion has been added in the form of a layer covering the substrate, the latter is either air-dried or dried using a heat treatment allowing, in particular, the solvent to evaporate and a chemical reaction to be generated in the binding agent.

By way of example, a dispersion of graphite particles in an aqueous solvent has a solid proportion equal to 18% by weight, a mean particle dimension of 1 to 2 micrometers with a maximum of 5 micrometers, a density of approximately 1.1 gr/cm3 and a pH value of approximately 11. Such dispersions can be obtained on the market.

According to another example, the dispersion contains as solvent isopropanol and graphite plates having diameters essentially between 20 and 40 micrometers. High absorption coefficients are observed, of at least 80% for wavelengths comprised between 2 μm and 20 μm, for absorption layers formed from such dispersions and having a thickness of around 2 micrometers.

Preferably using spray coating, relatively thin absorption layers, of around 2 micrometers, can be deposited, with graphite plates of relatively high diameter, particularly of a mean value of around 10 micrometers with a maximum of around 100 micrometers. Such a dispersion contains, for example, isoproponal and petrol ether as solvent and a binding agent in the form of acrylic resin. With such dispersions, structured absorption layers have been obtained with absorption coefficients higher than 90%. Such dispersions are available on the market. Of course, those skilled in the art will know how to determine which is the appropriate dispersion for a given substrate, particularly a semiconductor substrate and/or a specific metallisation. Such determination will depend, in particular, on the deposition method and the appropriate viscosity of the dispersion used.

As already mentioned hereinbefore, it is possible for the structured absorption layer to form also the top electrodes of the sensor pixels. Given the electrical properties of graphite, it is possible to obtain elementary zones having relatively low resistance. Electric resistance depends, in particular, on the size of the particles, the type of binding agent and its concentration, as well as the drying temperature of the layer.

A first implementation of the method for manufacturing at least one infrared sensor according to the invention will be described hereinafter. Taking by way of example a silicon plate as a base, a plurality of pixels is partially formed in accordance with a conventional method suited to the type of sensor made. Thus a substrate 24 is obtained, in which a plurality of pixels is partially formed, as shown in FIG. 2. The method includes a step of forming a structured infrared light absorption layer including the following sub-steps:

deposition of a photoresist layer forming a top layer of said substrate;

definition of a plurality of elementary absorption zones by a photolithographic process;

deposition of a dispersion layer on the substrate;

addition of specific solvent to dissolve said photoresist layer outside said elementary zones with elimination of the absorption layer formed by the dispersion also outside said elementary zones.

The method described here is close to the “lift off” process known to those skilled in the art for the manufacture of semiconductor circuits.

The dispersion layer is spread in a substantially uniform manner using one of the aforementioned techniques, particularly by a spinner rotating at a speed of 2000 revolutions/minute for a period of around 60 seconds. The operation of drying the dispersion layer to obtain a hard, solid absorption layer is carried out on a heating plate at around 120° for around one minute for a layer around 2 micrometers thick. Those skilled in the art will know how to choose the correct values for the aforementioned parameters depending on the dispersion used and particularly its viscosity.

By way of example, acetone will be used as a solvent to dissolve the layer of photoresist outside the elementary absorption zones defined by photolithography. Acetone will have virtually no effect in the elementary zones on the absorption layer, whereas outside these zones, because of the dissolution of the photoresist, the dispersion layer is mechanically removed.

Finally, the sensor or the batch of sensors is cleaned for example using isoproponal and distilled water.

Other methods of forming the structured infrared light absorption layer can be envisaged by those skilled in the art. A second implementation of the method according to the invention will be quickly described wherein the conventional photolithographic technique is replaced by the use of a contact mask. In this second implementation, the step of forming a structured layer using a dispersion of colloidal particles includes the following sub-steps:

addition of a mask having a plurality of apertures on the substrate in which pixels are partially formed, this plurality of apertures defining a plurality of elementary zones respectively associated with the pixels;

deposition of a dispersion layer covering the substrate and the mask, particularly using one of the aforementioned techniques;

removal of the mask so as to partially remove the layer thus deposited.

The absorption layer is structured by removal of the mask, the inner cohesion of the deposited layer and its adherence to the substrate are determined such that this layer remains solidly fixed to the substrate in the regions of the mask apertures.

1. Method for manufacturing at least one infrared sensor (2) including a step for forming a structured infrared light absorption layer (20) at the top surface of a substrate (24) in which a plurality of pixels (12) of said at least one infrared sensor are partially formed, characterised in that, in said structured layer forming step, a dispersion of colloidal is deposited so as to form an absorption layer covering said substrate and said absorption layer is then partially removed to form a plurality of elementary absorption zones (20) respectively associated to a plurality of pixels and defining said structured layer.

2. Manufacturing method according to claim 1, characterised in that said step of forming a structured layer (“lift off”) includes the following sub-steps:
depositing a photoresist layer forming a top layer of said substrate;
defining said plurality of elementary zones by a photolithographic process;
depositing said absorption layer formed of colloidal particles;
adding a solvent to dissolve said photoresist layer located outside of said elementary zones with removal of said absorption layer outside of these elementary zones.

3. Manufacturing method according to claim 1, characterised in that said structured layer forming step includes the following sub-steps:
adding a mask having a plurality of apertures on said substrate, said plurality of apertures then defining said plurality of elementary absorption zones;
depositing said absorption layer formed of colloidal particles;
removing said mask so as to partially remove said substantially uniform layer so as to only leave said layer in said plurality of elementary absorption zones.

4. Manufacturing method according to any of claims 1 to 3, characterised in that said colloidal particles are formed of graphite plates whose diameter is less than 100 micrometers, the thickness of said structured layer being less than 10 micrometers.

5. Manufacturing method according to any of claims 1 to 3, characterised in that said colloidal particles are formed of metal oxides, particularly iron, copper or manganese oxides.

6. Infrared sensor (2) including a structured infrared light absorption layer (20), characterised in that said structured layer is formed of colloidal particles and a binding agent.

7. Sensor according to claim 6, characterised in that said colloidal particles are graphite plates.

8. Sensor according to claim 7, characterised in that the diameter of said graphite plates is less than 100 micrometers.

9. Sensor according to claim 6, characterised in that said colloidal particles are metal oxides, particularly iron, copper or manganese oxides.

10. Sensor according to any of claims 6 to 9, characterised in that the thickness of said structured layer is less than 10 micrometers.

11. Sensor according to any of claims 6 to 10, characterised in that said structured layer defines a plurality of elementary absorption zones each associated with a plurality of pixels (12) forming said sensor.

12. Sensor according to claim 11, characterised in that said elementary absorption zones are electrically conductive and also form the top electrodes of the plurality of pixels.
